(19) United States
(12) Patent Application Publication
(10) Pub. No.: US 2026/0371009 A1
(43) Pub. Date: Nov. 19, 2026

(54) PASSIVE RESONATOR AND METHOD FOR MAKING A PASSIVE RESONATOR

(71) Applicant: POWERSOFT S.P.A., SCANDICCI FIRENZE (IT)

(72) Inventor: CLAUDIO LASTRUCCI, LASTRA A SIGNA FI (IT)

(21) Appl. No.: 19/675,888

(22) Filed: May 13, 2026

(30) Foreign Application Priority Data
May 15, 2025 (IT) 102025000011022

(51) Int. Cl. H04R 7/12; H04R 1/02; H04R 7/20

(52) U.S. Cl. CPC H04R 7/127; H04R 1/021; H04R 7/20; H04R 2307/025

(57) ABSTRACT

A passive resonator for a loudspeaker box defining an internal space which contains air comprises: an anchoring element, connectable to a housing of the loudspeaker box; a suspension, connected to the anchoring element, and a radiator, connected to the suspension so as to move relative to the anchoring element along a longitudinal axis. The passive resonator is characterized in that it is made in one piece out of an elastic material, so as to deform along the longitudinal axis responsive to a variation in the pressure of the air inside the internal space.

### CROSS-REFERENCE TO RELATED APPLICATIONS

This application claims the benefit of Italian Application No. 102025000011022 filed on May 15, 2025, the entire disclosure of which is hereby incorporated herein by reference.

### FIELD OF THE INVENTION

This invention relates to a passive resonator for a loudspeaker box, a loudspeaker box and a method for making a passive resonator for a loudspeaker box.

A passive resonator is an acoustic device used for improving the low frequency response of loudspeaker boxes.

A passive resonator is generally made up of a radiator (or diaphragm), without a direct electric power supply, and a suspension, connected to the radiator to allow the radiator to move responsive to a variation in the pressure generated by an active component of the loudspeaker box. The passive resonator works using the resonant frequency, that is to say, the frequency at which the mass of the radiator and the compressibility of the air in the loudspeaker box create a resonating system. Typically, the suspension is made of an elastomeric material, while the radiator is made of a rigid material.

Examples of passive resonators are described in patent documents US2006291684A1 and US2005157900A1. However, the diaphragm and the suspension system may be damaged by shocks, wear or excessive temperature swing.

Another examples are provided by patent documents US2019/020945A1 and US2025/142249A1; however, neither those documents provide solutions capable of satisfying the market’s needs.

### Background of the Invention

The aim of this disclosure is to provide a passive resonator and a method for making a passive resonator to overcome the above mentioned disadvantages of the prior art.

In particular, the aim of this disclosure is to provide a passive resonator which is compact and easy to install; a further aim of the invention is to provide a passive resonator which is robust.

This aim is fully achieved by the passive resonator and the method for making a passive resonator, as described in this disclosure and as characterized in the appended claims.

### BRIEF SUMMARY OF THE INVENTION

The passive resonator is intended for use in a loudspeaker box, where the loudspeaker box defines an internal space containing air.

The passive resonator comprises an anchoring element, connectable to a housing of the loudspeaker box. The passive resonator comprises a suspension, connected to the anchoring element. The passive resonator comprises a radiator, connected to the suspension so as to move relative to the anchoring element along a longitudinal axis.

In particular, the passive resonator is made in one piece (that is, the anchoring element, the suspension and the radiator are made in a single piece). The passive resonator is made out of an elastic material, so as to deform along the longitudinal axis responsive to a variation in the pressure of the air inside the internal space. In particular, the suspension and the radiator deform responsive to the variation in the air pressure inside the internal space, while the anchoring element remains connected to the housing. Thus, the suspension and the radiator constitute a movable, deformable portion of the passive resonator, and the anchoring element defines a fixed portion of the passive resonator.

It should be noted that the term "deformable" is used to mean that the passive resonator (in particular, the suspension and the radiator) are capable of changing their shape responsive to the variation in the pressure of the air inside the internal space.

In particular, in use, the passive resonator is configured for deforming itself.

The passive resonator of patent document US2019/020945A1 is not deformable as a whole, because the mass component (indicated in figures by the reference number 140) is described as a rigid element that moves together with the radiator without undergoing deformation (see paragraph [0058]); any described deformabilty is limited solely to specific portions of the elastomeric member, namely the suspenction (indicated by the reference number 132) and the snap-attach region along the peripheral border (indicated by reference number 138), which locally deform to enable attachment and sealing.

The fact that the passive resonator is made in one piece out of elastic material confers robustness and flexibility to the resonator, while at the same allowing the movement necessary for the operation of the resonator. In particular, the radiator defines a mass; the mass is configured to generate a displacement of air (i.e. a variation in the pressure of the air). Said displacement of air ultimately generates a sound.

More in particular, the passive resonator defines a mass; the mass is configured to generate a displacement of air (i.e. a variation in the pressure of the air). Said displacement of air ultimately generates a sound.

Preferably, the elastic material of the passive resonator is homogeneous. The passive resonator has axisymmetric geometry. In particular, the compliance of the passive resonator is homogeneous; more specifically, the compliance of the suspension is homogeneous along the perimeter of the suspension. In particular, the mass of the passive radiator is distributed homogeneously parallelly and transversely to the longitudinal axis.

In effect, it is important that the passive resonator is characterized by symmetry about the axis of oscillation (that is, the longitudinal axis); in particular, the term "symmetry" is used to mean that the resonator has geometric symmetry (in this case, the passive resonator is axisymmetric), compliance symmetry (the suspension or perimeter diaphragm has homogeneous compliance along its entire perimeter), and symmetry of mass distribution (that is, the material of the passive resonator has homogeneous distribution of mass).

The passive resonator can be symmetric with respect to a transverse axis perpendicular to the longitudinal axis. In other words, the radiator, the suspension and the anchoring element are symmetric with respect to a transverse axis perpendicular to the longitudinal axis.

The passive resonator is characterized by a first oscillation mode (resonance) with a non-zero mean. In particular, the passive resonator is configured to move with reciprocating motion along the longitudinal axis between a bottom dead centre and a top dead centre. The passive resonator is configured to deform along the longitudinal axis between a configuration of maximum deformation and a configuration of minimum deformation. In the configuration of maximum deformation towards the outside of the internal space of the loudspeaker box, the internal space of the loudspeaker box is at its maximum and the passive resonator is at the top dead centre.

In the configuration of maximum deformation towards the inside of the loudspeaker box, the internal space of the loudspeaker box is at its minimum and the passive resonator is at the bottom dead centre.

In the configuration of minimum deformation, the internal space of the loudspeaker box is intermediate between its maximum and its minimum and the passive resonator is undeformed. Thus, the passive resonator deforms and at the same time moves along the longitudinal axis cyclically in a period T, between a configuration of maximum deformation towards the inside of the loudspeaker box, corresponding to the minimum volume of the space inside the loudspeaker box, and a configuration of maximum deformation towards the outside of the loudspeaker box, corresponding to the maximum volume of the space inside the loudspeaker box; during the movement and the deformation of the passive resonator, the internal space of the loudspeaker box varies continuously with a monotonic trend (rising in one semi-period and falling in the other).

The two trends, i.e., translation and deformation, are in phase with each other; thus, when the passive resonator is at the top dead centre, the configuration is that of maximum deformation towards the outside, and when the resonator is at the bottom dead centre, the configuration is that of maximum deformation towards the inside.

The contributions given by the variation in the volume of the internal space of the loudspeaker box are summed to give a first oscillation mode with a non-zero mean.

Advantageously, the passive resonator is configured so that the pressure variation inside the loudspeaker box produces excitation of the passive radiator such as to produce a non-zero variation in the volume of the internal space in each of the two movement directions.

A first oscillation mode with non-zero mean can be obtained by acting on one of the following design parameters: compliance, mass distribution and geometry.

Generally, using a homogeneous material makes it possible to obtain both homogeneous mass distribution and homogeneous compliance.

Preferably, the anchoring element extends around the longitudinal axis. The anchoring element may extend around the longitudinal axis in circular fashion or according to any other shape (for example, square or parallelepiped).

The anchoring element has at least one contact surface, configured to come into contact with at least one corresponding locking element of the loudspeaker box. In particular, the anchoring element has a first contact surface and a second contact surface, configured to come into contact with corresponding locking elements of the loudspeaker box.

Preferably, the first contact surface and the second contact surface are transverse to the longitudinal direction. In other words, they extend transversely to the longitudinal direction, in particular perpendicularly to the longitudinal direction. Thus, the first contact surface and the second contact surface are parallel to each other.

The anchoring element has a longitudinal thickness; the first contact surface and the second contact surface are spaced from each other by a distance defining the thickness of the anchoring element along the longitudinal direction.

In particular, the anchoring element comprises a third contact surface. The third contact surface is transverse to the first contact surface and to the second contact surface. The third contact surface is connected to the first contact surface and to the second contact surface.

Thus, the anchoring element defines a perimeter edge by which the suspension of the passive resonator (as well as the radiator) is connected to the housing of the loudspeaker box.

The suspension is interposed (radially to the longitudinal axis) between the radiator and the anchoring element. Preferably, the suspension has a longitudinal thickness which is less than the longitudinal thickness of the anchoring element.

The radiator has an outside surface which extends perpendicularly to the longitudinal direction.

Preferably, the radiator has a plurality of blind cavities. The cavities are disposed on the outside surface of the radiator. Preferably, the cavities are disposed around the longitudinal axis and are uniformly spaced from each other.

In particular, the outside surface of the radiator includes an inside face, facing towards the internal space of the loudspeaker box, and an outside face, opposite the inside face. In other words, the outside surface includes a first face (i.e. the inside face) operatively facing the internal space of the loudspeaker box, and a second face (i.e. the outside face), opposite the first face. The plurality of blind cavities includes a first group of cavities, disposed around the longitudinal axis on the inside face, and a second group of cavities, disposed around the longitudinal axis on the outside face. The first group of cavities and the second group of cavities are disposed on the respective faces so that the radiator is symmetrical with respect to a transverse plane perpendicular to the longitudinal axis.

More specifically, the cavities of the first and second groups are disposed in pairs where, for each pair, a cavity of the first group is aligned with a cavity of the second group along a longitudinally oriented axis. The cavities of each pair are disposed symmetrically about a midplane, where the midplane cuts the radiator in half perpendicularly to the longitudinal axis.

In an example, each cavity extends radially to the longitudinal axis. Each cavity may have a tapered shape towards the longitudinal axis. In other words, each cavity has, transversely to the longitudinal axis, a width which becomes progressively smaller towards the longitudinal axis.

In an example, the elastic material of the passive resonator is an elastomer. The elastomer has a hardness of between 10 and 70 ShoreA.

In particular, the elastomeric material may be silicone-based, treated, for example, by platinum catalysis.

Preferably, the passive resonator is made by injection moulding.

This disclosure also provides a loudspeaker box.

The loudspeaker box comprises a passive resonator which is made according to one or more features set out in this disclosure.

In particular, the loudspeaker box comprises a housing, and the anchoring element is connected to the housing. In an example, the housing defines the internal space of the loudspeaker box.

The housing may comprise a seat, configured to accommodate the anchoring element. The loudspeaker box may comprise a locking device, configured to fix the passive resonator in the housing. In particular, the locking device is configured to fix the anchoring element to the seat, so that the first contact surface of the anchoring element is in contact with the seat of the housing, and the second contact surface of the anchoring element is in contact with the locking device.

In particular, the loudspeaker box comprises a sound transducer (loudspeaker), configured to generate the pressure variation.

In an embodiment, the locking device includes a ring nut, configured to be fastened, to the housing, and a crown. Operatively, the crown is interposed between the ring nut and the anchoring element of the passive resonator. The ring nut is configured to lock the crown to the anchoring element.

In an example, the crown has a bottom portion, extending transversely to the longitudinal axis and configured to be in contact with the second contact surface of the anchoring element.

Thus, the bottom portion of the crown and the seat of the housing define the locking elements of the loudspeaker box.

The crown has an outer lateral portion, connected to the bottom portion and configured to be in contact with the housing; the crown has an inner lateral portion, connected to the bottom portion and opposite the outer lateral portion. In particular, the bottom portion extends between a first end and a second end; the outer lateral portion is connected to the bottom portion at the first end and the inner lateral portion is connected to the bottom surface at the second end. The inner lateral portion is inclined towards the longitudinal axis.

The crown has a top portion, opposite the bottom portion and connected to the inner lateral portion and to the outer lateral portion. The top portion is configured to come into contact with the ring nut.

Preferably, the bottom portion and the outer lateral portion make an angle greater than 90 degrees with each other. In other words, the bottom portion is inclined relative to a plane which is perpendicular to the longitudinal axis. A longitudinal length of the inner lateral portion may be greater than a longitudinal length of the outer lateral portion.

In an example, the bottom portion extends transversely to the longitudinal axis to a greater extent than the transverse thickness of the anchoring element.

The fact that the outer lateral portion and the bottom portion make an angle greater than 90 degrees and that the bottom portion extends transversely to the longitudinal axis to a greater extent than the transverse thickness of the anchoring element limits the friction between the components when the passive resonator deforms elastically.

The geometry of the system, is designed so that the first mechanical resonance mode has a non-zero mean. This allows the pressure inside the diffuser to produce consistent deformation, ensuring the movement of an acoustic volume at the resonance frequency.

Additionally, the shape and design of the component allow moving the upper mechanical modes at higher frequencies than the operating band of the resonator. These modes, being designed with a zero dislocation mean, do not contribute to the acoustic emission. Since the energizing of the system depends mainly on the pressure inside the diffuser, these modes are not activated during operation, thus preventing interferences and ensuring that there is a single effective acoustic resonance frequency. This feature improves sound emission at low frequencies.

Another advantage of this solution is that it is capable of moving a larger volume of air than a conventional system. The total volume moved is given by the sum of the pistonic volume at the circumference of the movable part and the additional volume generated by the deformation of the body by effect of the pressure, thus allowing overall size to be reduced.

This disclosure also provides a method for making a passive resonator for a loudspeaker box defining an internal space which contains air.

The method comprises a step of providing: an anchoring element, connected to a housing of the loudspeaker box; a suspension, connected to the anchoring element; a radiator, connected to the suspension so as to move relative to the housing along a longitudinal axis.

In particular, the passive resonator is made in one piece out of an elastic material, so as to deform along the longitudinal axis responsive to a variation in the pressure of the air inside the internal space.

Preferably, the anchoring element extends around the longitudinal axis and has a first contact surface and a second contact surface. The first contact surface and the second contact surface are transverse to the longitudinal axis and are configured to come into contact with corresponding locking elements of the loudspeaker box.

The radiator has an outside surface, extending perpendicularly to the longitudinal axis and including an inside face, facing towards the internal space of the housing, and an outside face, opposite the inside face. Preferably, the radiator has a plurality of blind cavities. In particular, the plurality of blind cavities includes a first group of blind cavities, disposed on the inside face of the radiator around the longitudinal axis, and a second group of blind cavities, disposed on the outside face around the longitudinal axis.

More specifically, the cavities of the first and second groups are disposed in pairs where, for each pair, a cavity of the first group is aligned with a cavity of the second group along a longitudinally oriented axis. The cavities of each pair are disposed symmetrically about a midplane, where the midplane cuts the radiator in half perpendicularly to the longitudinal axis.

In an example, the method comprises a step of injection moulding to make the passive resonator, preferably out of an elastomeric material. The method may comprise a step of treating the passive resonator by platinum catalysis.

This disclosure also provides a method for making a loudspeaker box comprising a passive resonator, where the passive resonator is made according to one or more of the features set out in this disclosure.

The method may comprise a step of placing the locking element onto the housing directly or by means of a basket connected to the housing.

In an example, the method comprises a step of providing a housing of the loudspeaker box, where the housing comprises a seat, and a step of providing a locking device. The method may comprise a step of housing the passive resonator by placing the anchoring element in the housing seat. The method may comprise a step, via the locking device, of fixing the passive resonator to the housing by fixing the locking element to the seat. Preferably, the locking device is sealedly fixed in the housing seat.

The method may comprise a step of providing a sound transducer.

In an example, the locking device includes a ring nut and a crown. The crown has a bottom portion, extending transversely to the longitudinal axis, an outer lateral portion, connected to the bottom portion, and an inner lateral portion, connected to the bottom portion and opposite the outer lateral portion.

The anchoring element has a first contact surface and a second contact surface which are transverse to the longitudinal direction. In particular, the locking element comprises a third contact surface, transverse to the first contact surface and to the second contact surface. The third contact surface is connected to the first contact surface and to the second contact surface.

The step of locking the passive resonator to the seat, in particular of the anchoring element, comprises a step of bringing the bottom portion into contact with the second contact surface of the anchoring element, and a step of bringing the outer lateral portion into contact with the housing.

The method may comprise a step of fixing the ring nut to the housing so that the crown is interposed between the ring nut and the passive resonator.

### BRIEF DESCRIPTION OF THE DRAWINGS

This and other features will become more apparent from the following description of a preferred embodiment, illustrated by way of non-limiting example in the accompanying drawings, in which:

FIG. 1A shows a passive resonator according to the prior art;

FIG. 1B shows a passive resonator according to one or more features of this invention;

FIG. 2 shows a cross section of the passive resonator of FIG. 1B;

FIGS. 3A and 3B show the passive resonator of FIG. 1B respectively in a configuration where it is undeformed and in a configuration where it is deformed responsive to a pressure variation;

FIG. 4A shows a passive resonator according to one or more features of this invention, placed inside a housing;

FIG. 4B shows a detail of the passive resonator of FIG. 4A according to one or more features of this invention;

FIG. 4C shows an exploded view of a loudspeaker box comprising a passive resonator according to one or more features of this invention;

FIG. 4D shows a loudspeaker box comprising a passive resonator according to one or more features of this invention;

FIGS. 5A and 5B show a passive resonator according to the prior art, deformed responsive to a pressure variation;

FIGS. 6A and 6B show an example of a passive resonator deformed responsive to a pressure variation, where the first oscillation mode has a zero mean.

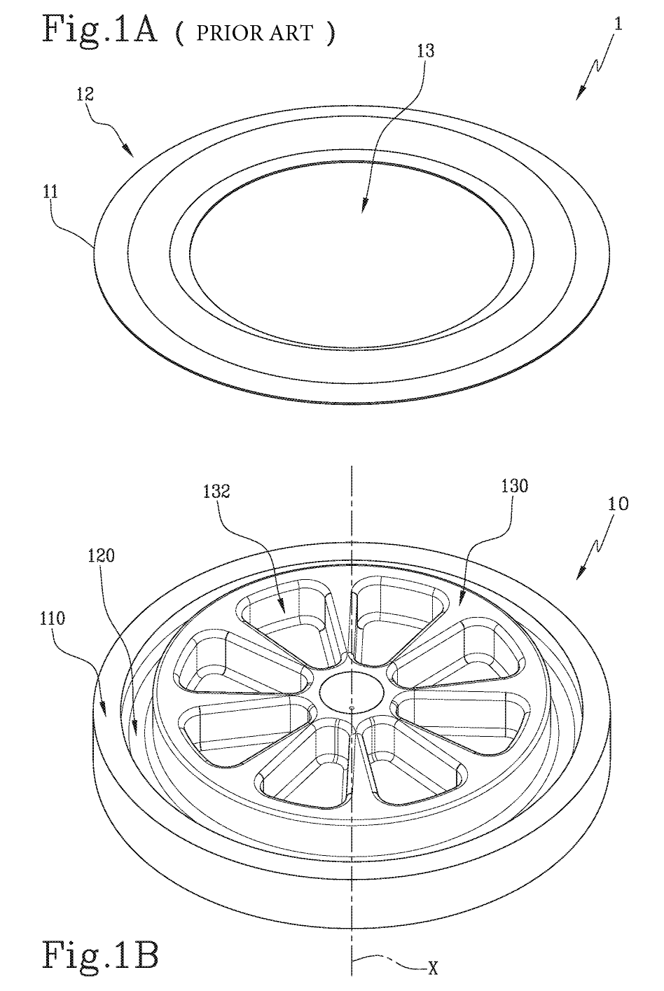

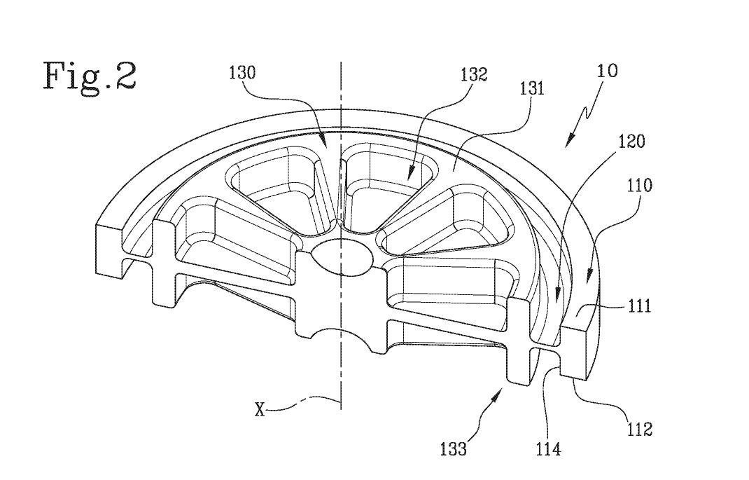

### DESCRIPTION OF EXAMPLE EMBODIMENTS

The numeral 10 in the drawings denotes a passive resonator according to this invention, and the numeral 1 a passive resonator according to the prior art.

The passive resonator 1 according to the prior art comprises a suspension 12 and a radiator 13, connected to the suspension 12. The passive resonator 10 according to this invention comprises a suspension 120 and a radiator 130, connected to the suspension 120. The passive resonator 10 also comprises an anchoring element 110, connectable to a housing 20 and connected to the suspension 120. In practice, the anchoring element 110 allows the suspension 120 and the radiator 130 to be connected to the housing 20.

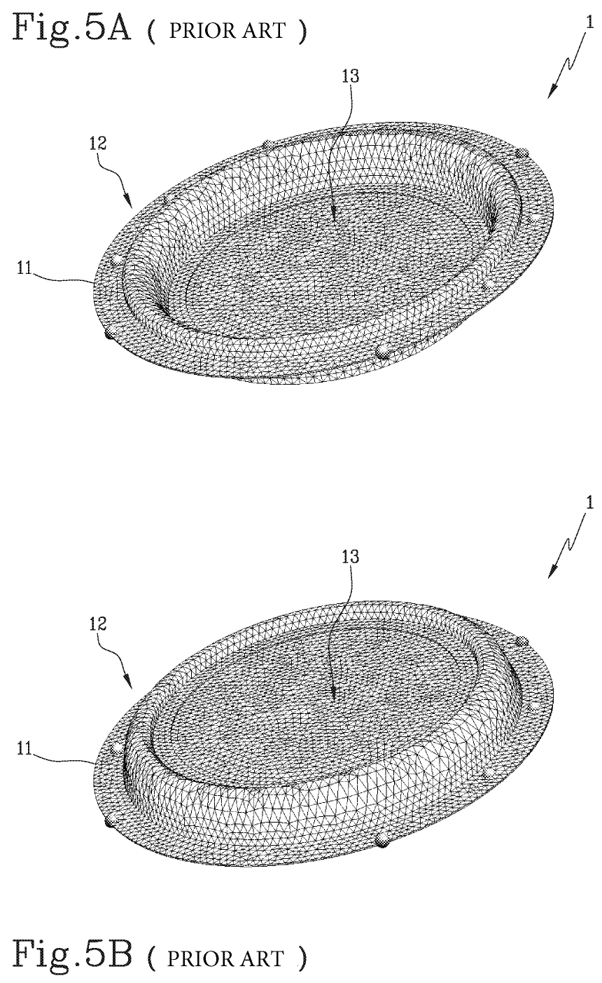

In the passive resonator 1 according to the prior art, the anchoring element 11 is defined by a perimeter edge of the suspension 12. It is through the anchoring element 11 that the passive resonator 1 is connectable to the housing 20. In the passive resonator 1 according to the prior art, the suspension 12 is flexible so as to allow the radiator 13 to move, relative to the housing 20 and relative to the anchoring element 11, which remains fixed to the housing 20, responsive to a variation in the air pressure inside a loudspeaker box 100 on which the resonator is mounted. FIGS. 5A and 5B show the passive resonator 1 according to the prior art, deformed as a result of a pressure variation in the loudspeaker box 100.

The passive resonator 10 according to this invention is made in one piece out of an elastic material; that way, responsive to the variation in the air pressure inside the loudspeaker box 100, the radiator 130 and the suspension 120 move and deform relative to the housing 20 and relative to the anchoring element 110, which remains fixed to the housing 20.

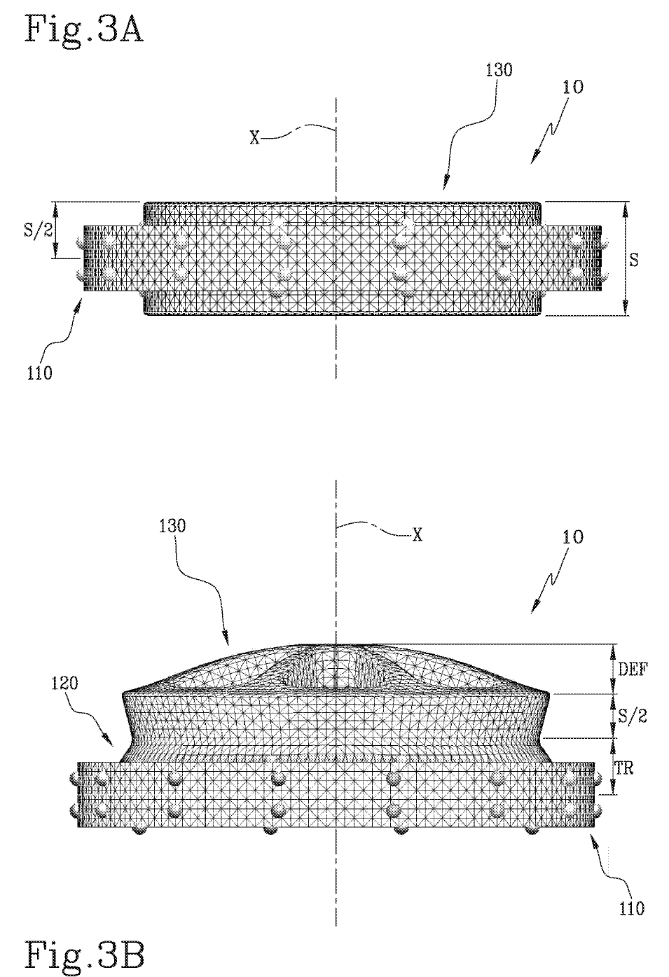

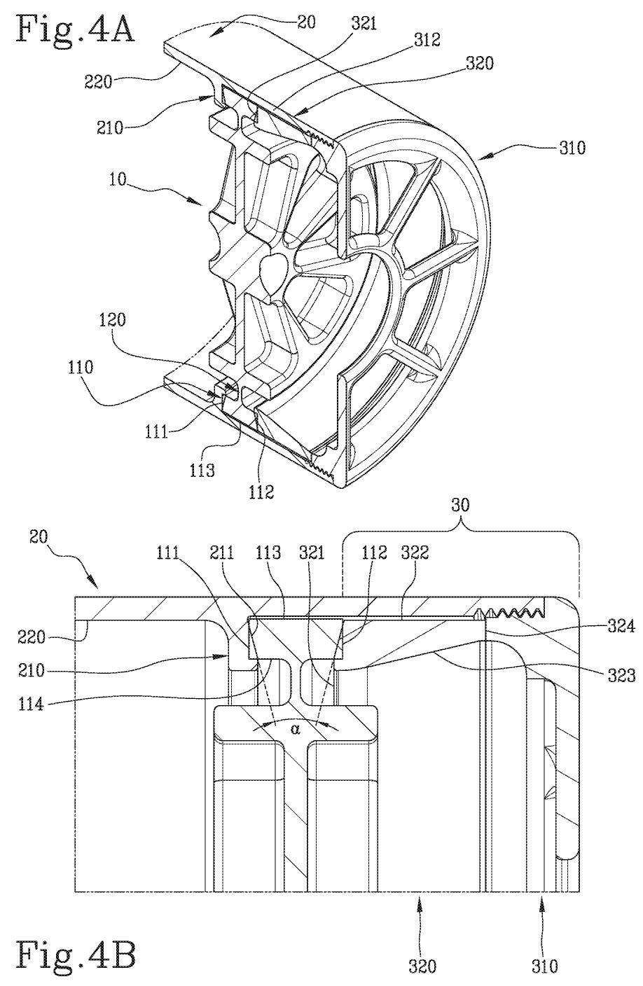

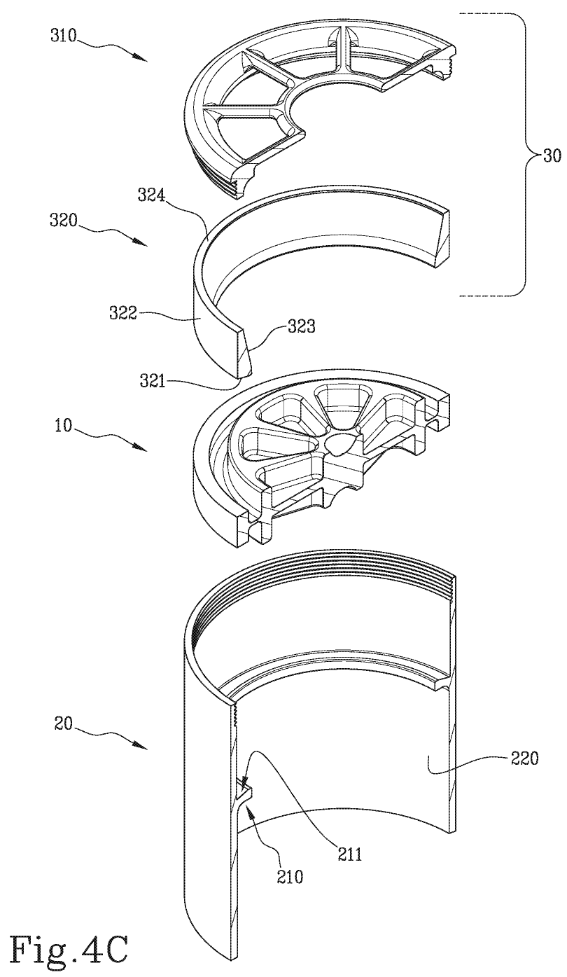

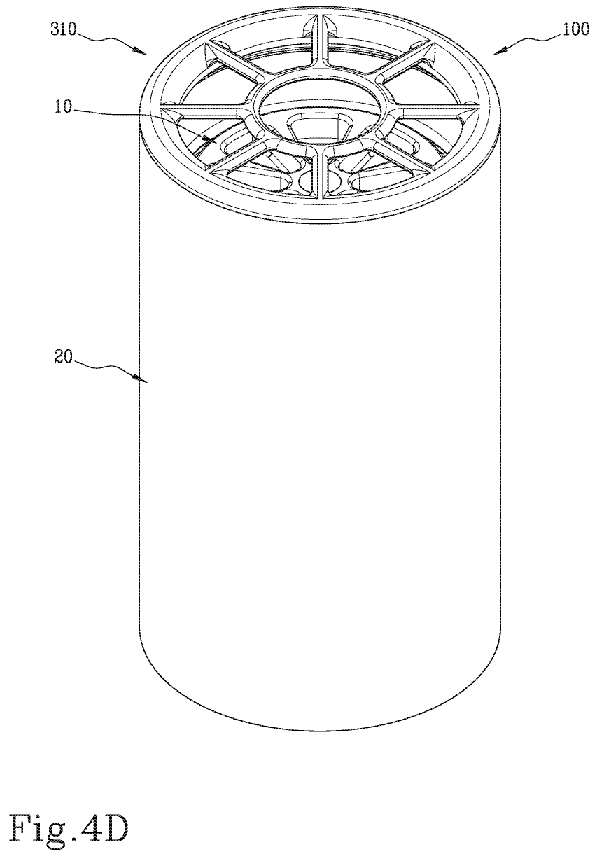

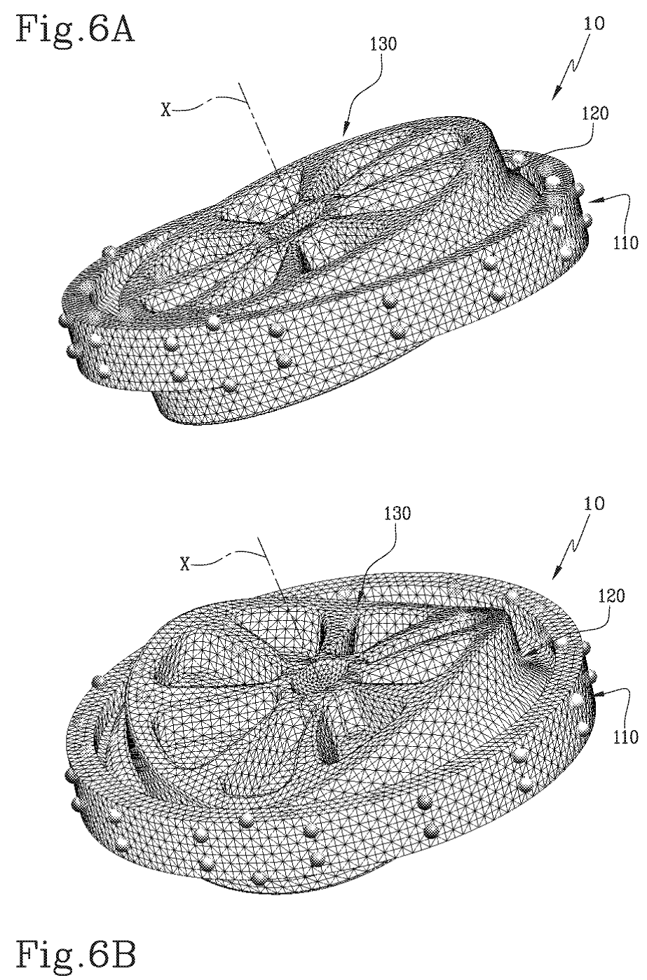

The passive resonator 10 according to this invention has a first oscillation mode with a non-zero mean. The deformation of the passive resonator 10 occurs concurrently (and in phase) with the translation of the passive resonator 10 itself along the longitudinal axis X; this behaviour is illustrated for example in FIG. 3. FIGS. 6A and 6B, on the other hand, show examples in which the deformation and translation of the passive resonator 10 are not in phase with each other, resulting in a first oscillation mode having a zero mean.

The passive resonator 10 extends transversely to the longitudinal axis X. The passive resonator 10 shown in the drawings has a circular shape; however, the passive resonator 10 might also have other shapes.

The anchoring element 110 extends around the longitudinal axis X so as to define a ring. The anchoring element 110 has a first contact surface 111 and a second contact surface 112 which are transverse to the longitudinal axis X and parallel to each other. The anchoring element 110 has a third contact surface 113 which is connected to the first contact surface 111 and to the second contact surface 112. The third contact surface 113 extends transversely to the first contact surface 111 and to the second contact surface 112.

The anchoring element 110 has a fourth contact surface 114 which is connected to the first contact surface 111 and to the second contact surface 112, and which is opposite the third contact surface 113. The suspension 120 is connected to the fourth contact surface 114 of the anchoring element 110.

The anchoring element 110 has a longitudinal thickness defined between the first contact surface 111 and the second contact surface 112. The anchoring element 110 has a transverse thickness defined between the third contact surface 113 and the fourth contact surface 114.

Preferably, the suspension 120 is connected to the anchoring element 110 at a midpoint of the longitudinal thickness of the anchoring element 110.

The suspension 120 extends around the longitudinal axis X. The suspension 120 has a longitudinal thickness and a transverse thickness relative to the longitudinal direction. The longitudinal thickness of the suspension 120 is less than the longitudinal thickness of the anchoring element 110.

The radiator 130 has an outside surface 131 which extends perpendicularly to the longitudinal direction. The outside surface 131 includes an inside face 131A, facing towards the internal space of the loudspeaker box 100, and an outside face 131B, opposite the inside face 131A.

The radiator 130 has a plurality of blind cavities 132, disposed on the outside surface 131. The plurality of blind cavities 132 includes a first group of cavities 132 and a second group of cavities 132. The cavities 132 of the first group are disposed on the inside face 131A of the surface 131, around the longitudinal axis X and uniformly spaced from each other. The cavities 132 of the second group are disposed on the outside face 131B of the surface 131, around the longitudinal axis X and uniformly spaced from each other. In particular, the blind cavities 132 are disposed in pairs where each pair comprises a blind cavity 132 of the first group and a blind cavity 132 of the second group. Additionally, for each pair, the blind cavity 132 of the first group is aligned with the blind cavity 132 of the second group along a longitudinally oriented axis.

The radiator 130 has a longitudinal thickness. The longitudinal thickness of the radiator 130 varies along a plane of extension of the radiator 130, so as to have zones with reduced thickness at the blind cavities 132 (in particular at the pairs of cavities 132). The cavities 132 are disposed in such a way that the radiator 130 is symmetrical about a midplane which cuts the radiator 130 in half along the longitudinal thickness.

In an example, each cavity 132 extends radially to the longitudinal axis X so as to have a tapered shape towards the longitudinal axis X. In an example, the radiator 130 has a central portion, aligned with the longitudinal axis X. The central portion may have an additional blind cavity, which is radially symmetrical about the longitudinal axis X. In another example, the central portion does not have cavities. The additional cavity may be present on the inside face 131A or on the outside face 131B. Preferably, when present, it is on both the inside face 131A and on the outside face 131B, for symmetry. The radiator 130 has a perimeter edge 133, extending around the longitudinal axis X. The radiator 130 is connected to the suspension by the perimeter edge 133. At the perimeter edge 133, the longitudinal thickness of the radiator 130 is greater than the reduced thickness zones.

Thus, responsive to a pressure variation inside the loudspeaker box 100, the radiator 130 and the suspension 120 are configured to move along the longitudinal axis X, while the anchoring element 110 remains attached to the housing 20. In particular, the suspension 120 and the radiator 130 deform, by expanding and contracting, responsive respectively to an increase and a decrease in the air pressure.

The passive resonator 10 can be mounted inside a loudspeaker box 100. In particular, the passive resonator 10 is connectable to the housing 20 of the loudspeaker box 100.

In an example, the housing 20 comprises a wall 220 and a seat 210, connected to the wall 220 and configured to house the anchoring element 110 of the passive resonator 10.

The loudspeaker box 100 may comprise a locking device 30 to lock the passive resonator 10 to the housing seat 210.

In an example, the locking device 30 includes a ring nut 310 and a crown 320. The crown 320 is configured to be mounted in the loudspeaker box 100, between the passive resonator 10 and the ring nut 310. The ring nut 310 is configured to be fixed to the housing 20 so as to lock the crown 320. For example, the ring nut 310 may have a thread configured to engage a corresponding thread provided in the housing 20 (in particular, in the wall 220 of the housing 20).

The crown 320 has a bottom portion 321, extending transversely to the longitudinal axis X and configured to be in contact with the second contact surface 112 of the anchoring element 110. The crown 320 has an outer lateral portion 322, extending transversely to the bottom portion 321 and connected to the bottom portion 321, the outer lateral portion 322 being configured to be in contact with the wall 230 of the housing 20. The crown 320 has an inner lateral portion 323, extending transversely to the bottom portion 321, connected to the bottom portion 321 and opposite the outer lateral portion 322.

The crown 320 has a top portion 324, extending transversely to the longitudinal axis X, connected to the outer lateral portion 322 and to the inner lateral portion 323. The top portion 324 is configured to come into contact with the ring nut 310. In particular, the inner lateral portion 323 is inclined to the longitudinal axis X towards the longitudinal axis X, so that a distance between the outer lateral portion 322 and the inner lateral portion 323 at the bottom portion 321 is greater than a distance between the outer lateral portion 322 and the inner lateral portion 323 at the top portion 324.

The bottom portion 321 may be inclined to a plane which is perpendicular to the longitudinal axis X, so that an angle (in particular, an angle measured inside the crown 320) made between the bottom portion 321 and the outer lateral portion 322 is greater than 90 degrees (and preferably less than 135 degrees). The seat 210 of the housing 20 comprises a supporting surface 211. The supporting surface 211 is configured to be in contact (preferably direct contact) with the first contact surface 111 of the anchoring element 110. The supporting surface 211 may be inclined to the plane which is perpendicular to the longitudinal axis X, so that an angle between the bottom portion 322 and the supporting surface 211 (measured at the seat of the anchoring element 110) is less than 90 degrees (and preferably greater than 45 degrees).

In an example, an angle α between the supporting surface 211 and the bottom portion 321 is between 0° (that is, the supporting surface 211 and the bottom portion 321 are parallel to each other) and 90°; preferably, the angle α between the supporting surface 211 and the bottom portion 321 is between 5° and 90°.

Purely by way of example, FIGS. 3A and 3B show the passive resonator 10 in the rest configuration (FIG. 3A) and in the operating configuration (FIG. 3B). The passive resonator 10 has a longitudinal thickness S defined between the outside face 131A and the inside face 131B of the radiator 130. Thus, S/2 denotes a longitudinal distance between a midpoint of the passive resonator 10 and the outside face 131A (or the inside face 131B). In the operating configuration, the passive resonator 10 translates by a longitudinal distance TR responsive to a variation in the air pressure; in addition, thanks to its elasticity, it deforms by a longitudinal quantity DEF. Thus, the volume of air displaced by the passive resonator 10 according to this invention is given by the contribution of the translation TR and the deformation DEF.

1. A passive resonator for a loudspeaker box defining an internal space which contains air:
an anchoring element , connectable to a housing of the loudspeaker box,
a suspension, connected to the anchoring element, and
a radiator, connected to the suspension so as to move relative to the anchoring element along a longitudinal axis,
the passive resonator being characterized in that is made in one piece out of an elastic material, so as to deform along the longitudinal axisresponsive to a variation in the pressure of the air inside the internal space.

2. The passive resonator according to claim 1, wherein the elastic material of the passive resonator is homogeneous and the passive resonator has an axisymmetric shape.

3. The passive resonator according to claim 2, wherein the suspension is uniformly compliant along the perimeter of the suspension and the passive radiator has a mass distribution which is uniform parallelly and transversely to the longitudinal axis.

4. The passive resonator according to claim 1, shaped in such a way that, in response to the variation in the air pressure inside the internal space, the elastic deformations of the resonator operate on the variation of internal space size consistently with the movements of the radiator along the longitudinal axis, so as to vary the internal space between a maximum space configuration and a minimum space configuration.

5. The passive resonator according to claim 1, configured to move with reciprocating motion along the longitudinal axis between a bottom dead centre and a top dead centre and to deform along the longitudinal axis between:
a configuration of maximum deformation outwards, where the internal space of the loudspeaker box is at its maximum and the passive resonator is at the top dead centre, and
a configuration of maximum deformation inwards, where the internal space of the loudspeaker box is at its minimum and the passive resonator is at the bottom dead centre.

6. The passive resonator according to claim 1, wherein the anchoring element extends around the longitudinal axis and has a first contact surface and a second contact surface, the first contact surface and the second contact surface being transverse to the longitudinal axis and configured to come into contact with corresponding locking elements of the loudspeaker box.

7. The passive resonator according to claim 1, wherein the radiator has an outside surface, extending perpendicularly to the longitudinal axis and a plurality of blind cavities, disposed on the outside surface of the radiator, uniformly spaced from each other around the longitudinal axis.

8. The passive resonator according to claim 7, wherein the outside surface of the radiator includes an inside face facing towards the internal space of the loudspeaker box, and an outside face, opposite the inside face, wherein the plurality of blind cavities includes a first group of cavities, disposed around the longitudinal axis on the inside face, and a second group of cavities, disposed around the longitudinal axis on the outside face.

9. The passive resonator according to claim 8, wherein the cavities of the first and second groups are disposed in pairs where, for each pair, a cavity of the first group is aligned with a cavity of the second group along a longitudinally oriented axis.

10. The passive resonator according to claim 7, wherein each cavity extends radially to the longitudinal axis and has a tapered shape towards the longitudinal axis.

11. The passive resonator according to claim 1, wherein the elastic material of the passive resonator is an elastomer having a hardness of between 10 and 70 ShoreA.

12. A loudspeaker box comprising a passive resonator according to claim 1, comprising a housing, wherein the housing defines the internal space of the loudspeaker box.

13. The loudspeaker box according to claim 12, wherein:
the anchoring element extends around the longitudinal axis and has a first contact surface and a second contact surface which are transverse to the longitudinal axis,
the housing comprises a seat, configured to accommodate the anchoring element,
the loudspeaker box comprising a locking device configured to fasten the passive resonator to the housing so that the first contact surface is in contact with the seat of the housing and the second contact surface is in contact with the locking device.

14. The loudspeaker box according to claim 12, comprising a sound transducer, configured to generate the variation in the air pressure.

15. A method for making a passive resonator for a loudspeaker box defining an internal space, comprising the following steps:
providing an anchoring element, connectable to a housing of the loudspeaker box, a suspension, connected to the anchoring element, and a radiator (130), connected to the suspension so as to move relative to the anchoring element along a longitudinal axis,
characterized in that the passive resonator is made in one piece out of an elastic material, so as to deform along the longitudinal axis responsive to a variation in the pressure of the air inside the internal space.

16. The method according to claim 15, wherein the passive resonator has an axisymmetric shape and the elastic material of the passive resonator is homogeneous.

17. The method according to claim 15, wherein the anchoring element extends around the longitudinal axis and has a first contact surface and a second contact surface, the first contact surface and the second contact surface being transverse to the longitudinal axis and configured to come into contact with corresponding locking elements of the loudspeaker box.

18. The method according to claim 15,
wherein the radiator has:
an outside surface , extending perpendicularly to the longitudinal axis and including an inside face, facing towards the internal space of the loudspeaker box, and an outside face, opposite the inside face;
plurality of blind cavities including a first group of blind cavities, disposed on the inside face of the radiator around the longitudinal axis, and a second group of blind cavities, disposed on the outside face of the radiator around the longitudinal axis.

19. The method according to claim 18, wherein the cavities of the first and second groups are disposed in pairs where, for each pair, a cavity of the first group is aligned with a cavity of the second group along a longitudinally oriented axis.

20. The method according to claim 15, comprising a step of injection moulding to make the passive resonator, wherein the elastic material of the passive resonator is an elastomer.

21. The method according to claim 15, wherein in response to the variation in the air pressure inside the internal space, the elastic deformations of the resonator operate on the variation of internal space size consistently with the movements of the radiator along the longitudinal axis, so as to vary the internal space between a maximum space configuration and a minimum space configuration.
